(19) United States
(12) Patent Application Publication
(10) Pub. No.: US 2024/0031244 A1
(43) Pub. Date: Jan. 25, 2024

(54) GRAPH-BASED VISUALIZATIONS OF NETWORK FLOWS USING ENTITY CLUSTERING

(71) Applicant: VMware, Inc, Palo Alto, CA (US)

(72) Inventors: Anthony Fenzl, Mountain View, CA (US); Vinith Podduturi, Palo Alto, CA (US); Suresh Nagar, Palo Alto, CA (US); Bo Jin, Santa Clara, CA (US); Lei Lei, Palo Alto, CA (US); Sam Ghardashem, Palo Alto, CA (US)

(21) Appl. No.: 17/871,141

(22) Filed: Jul. 22, 2022

(51) Int. Cl. H04L 41/22; H04L 41/0893; G06F 9/451; G06F 16/28; G06F 16/2455

(52) U.S. Cl. CPC H04L 41/22; H04L 41/0893; G06F 9/451; G06F 16/285; G06F 16/24552

(57) ABSTRACT

Systems and methods are described for providing a graphical user interface (“GUI”) for graph-based visualizations of network flows using entity clustering. In an example, an application service can periodically execute a job for assigning network entities to clusters according to a clustering type. The job can also include creating metadata about each cluster. The application service can store the assignments in a cache. A user can select to display a visualization of the network in the GUI based on the clustering type. The application service can detect any entities without cluster assignments and create a best guess assignment for them. The GUI can then display a visualization of the network according to the selected clustering type.

### BACKGROUND

Many businesses today use computer networks to support business functions. These computer networks can grow to be extremely vast and complex as the business itself grows, particularly with enterprises. Some businesses use software with scalable graph-based visualization of network flows to help administrators (“admins”) manage their networks. An example of such software is VMWARE's NSX INTELLIGENCE. NSX INTELLIGENCE visually combines workloads and their flows together into logical groups called communities, which allows users to visualize millions of network flows between thousands of workloads in a way that does not overwhelm the user.

NSX INTELLIGENCE analyzes network traffic that each workload creates, and then groups together workloads based on how many unique connections they share. This process is referred to as “flow similarity.” Although flow similarity provides an intuitive way of visually combining workloads for users, there is no “one size fits all” solution for doing so. For example, some businesses may find it useful to be able to manually group together their workloads, but this may not be practical for customers with large deployments of thousands of workloads.

Furthermore, network visualization software like NSX INTELLIGENCE faces a scalability problem. This is due to cluster assignments being calculated at the time the user attempts to view the network in the GUI. The larger and more complex a network is, the longer it can take to generate cluster assignments for the workloads. As a result, a user may have to wait 10, 20, 30 minutes or longer to view the network visualization while backend processes analyze all the workloads in the network. This is inefficient and frustrates users.

As a result, a need exists for improved clustering for graph-based network visualization software.

### SUMMARY

Examples described herein include systems and methods for providing a graphical user interface (“GUI”) for graph-based visualizations of network flows using entity clustering. In an example, an application for network visualization and security can include a backend service for assigning entities of a network to clusters according to various clustering types. As some examples, network entities can be clustered according to pre-assigned tags, labels, entity names, network flows, and so on. The application can include a front-end GUI that allows a user to select a clustering type, and the GUI can display a visualization of the network with the entities clustered according to the selected clustering type.

The clustering types can be separated into two categories: query-time and periodic. The application service can cluster assignments for query-time clustering types quick enough that the assignments can be generated when a user selects the clustering type. For example, for tag-based clustering, the application service can cluster entities by shared tags, which can be done at query-time with minimal load time for the user. On the other hand, periodic clustering types can require much more time to create the cluster assignments. To reduce load times for the user, the application service can schedule jobs for periodically creating cluster assignments for periodic clustering types. Each time the job is run, the cluster assignments can be saved to a cache. When a user selects to view the network according to a periodic clustering type, the server can retrieve the cached cluster assignments instead of creating the assignments at query time.

It is possible that changes can occur on the network between a scheduled job execution for a periodic clustering type and a user selecting to view the network according to that clustering type. To address this, the application service can check the entities in the cached cluster assignments against a list of entities in the network to ensure that no entities are missing from the cached cluster assignments. Rather than running the entire cluster assignment job again, the application service can create a best guess cluster assignment using a simplified method. Then, when the next scheduled job runs for the clustering type, the best guess cluster assignments can be overwritten with assignments created from the job.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for providing a GUI for graph-based visualizations of network flows using entity clustering.

FIG. 2 is a sequence diagram of an example method for providing a GUI for graph-based visualizations of network flows using entity clustering.

FIG. 3 is another flowchart of an example method for providing a GUI for graph-based visualizations of network flows using entity clustering.

FIG. 4 is an illustration of an example GUI for graph-based visualizations of network flows using entity clustering.

FIG. 5 is an illustration of an example GUI for graph-based visualizations of network flows using entity clustering.

FIG. 6 is an illustration of an example system for providing a GUI for graph-based visualizations of network flows using entity clustering.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for providing a GUI for graph-based visualizations of network flows using entity clustering. In an example, an application service can periodically execute a job for assigning network entities to clusters according to a clustering type. The job can also include creating metadata about each cluster. The application service can store the assignments in a cache. A user can select to display a visualization of the network in the GUI based on the clustering type. The application service can detect any entities without cluster assignments and create a best guess assignment for them. The GUI can then display a visualization of the network according to the selected clustering type.

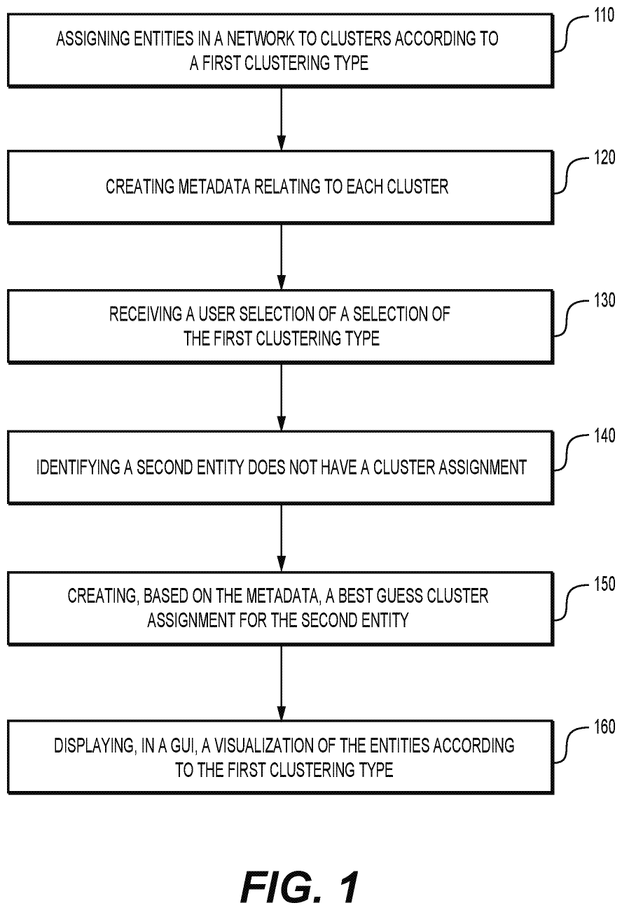

FIG. 1 is a flowchart of an example method for providing a GUI for graph-based visualizations of network flows using entity clustering. A network can be two or more computing devices that are connected to one another for the purpose of communicating data electronically. A network can also be a virtual network or include virtual components. For example, a network can be a software defined datacenter (“SDDC”) or virtual datacenter with a cloud-based datacenter architecture. In an SDDC, for example, virtual machines (“VMs”) can be deployed across various physical servers in a cloud-based computing environment. A VM can refer to a compute resource that uses software instead of a physical computer to run programs and deploy apps. The physical servers can be configured to allot a specified amount of computing resources to the network. These computing resources can include processing power (also referred to as “compute power”), storage (such as disk space), memory (such as random-access memory (“RAM”)), network connectivity, and the like.

At stage 110, a server can create cluster assignments for entities in a network to a set of clusters. As used herein, the term “server” refers to any device or computer program that manages access to a centralized resource or service in a network. The server can be a single server or a group of servers, including multiple servers implemented virtually across multiple computing platforms. For example, a server can be an operating system (“OS”) running on a single computing device or one or more VMs running in a cloud-based environment. The term “entity” can refer to any virtual or physical component that exchanges communications in the network. For example, an entity can be a VM or server, or a workload on a VM or server. As used herein, the term “workload” can refer to any program or application running on a computing device.

The server can host an application for network visualization and security. The application can include a GUI. The GUI can be a front-end interface of an application that provides a visualization of a model of a network, and a user can interface with the GUI to manage the network. One example of such an application is VMWARE's NSX INTELLIGENCE. The application can be hosted by a web server, and a user can access the application through a web browser. Alternatively, the application as a whole, the GUI, or other components of the application may be installed directly on a user's device. Actions described herein as being performed by the GUI can be performed by an application service executing on the server rather than the GUI itself.

The application can include one or more cluster creators. A cluster creator can be a backend service that is responsible for creating cluster assignments. There are multiple ways that entities can be clustered. For example, entities can be clustered based on network flows, user-defined labels, entity names, tags, and so on. The application can include multiple cluster creators, one for each type of clustering available. For example, the GUI can provide multiple options for displaying clustered entities. Each option can correspond to a different clustering type. The application can include a cluster creator for each available cluster type, and each cluster creator can be responsible for generating cluster assignments according to its corresponding cluster type.

The technique used for creating cluster assignments can depend on the clustering type. For example, one type of clustering that can be used is entity name-based clustering. In one example of entity name-based clustering, the cluster creator can cluster entities with shared name formats. As an example, production web servers in the network can use the name format “web-server-prod-[#]” where the name of each web server includes “web-server-prod-” followed by a number “#” unique to the web server, such as “web-server-prod-1” and “web-server-prod-2.” The cluster creator can assign all entities that include “web-server-prod” to the same cluster. Other entity types can be similarly clustered based on their shared name formats.

Another clustering type that can be used is network-flows-based clustering. With this clustering type, the cluster creator can cluster entities based on how data flows between the entities. For example, entities can be clustered based on factors like the port they communicate on, what communication protocol they use to communicate (e.g., Transmission Control Protocol (“TCP”), User Datagram Protocol (“UDP”)), and any shared security groups assignments. As an example, entities communicating on the same port number, using the same communication protocol, and assigned to a same security group can be assigned to the same cluster. As used herein, the term “port” refers to a logical transport layer that identifies where data or information is sent. A security group can designate security rules for inbound and outbound traffic on any device belonging to the group. For example, security groups can be used to filter network traffic to and from resources in a virtual network. The security rules can act as a filter for accepting or denying network traffic.

Entities can also be clustered based on shared data points. An example of such a clustering type is tag-based clustering. In tag-based clustering, users can assign tags to entities in the network for later retrieval by the system. In an example, the assigned tags can be stored as mappings in a location accessible by the cluster creator, such as in a database. The cluster creator can retrieve the entity-to-tag mappings from the database and cluster the entities based on shared tags. Other examples of shared data points that can be used for entity clustering can include processes running on the entity, firewall settings, user-applied labels, and so on. The clustering types described herein are exemplary and are not meant to be limiting in the types of clustering that can be used.

The clustering types can be separated into two categories: query-time clustering and periodic clustering. Query-time clustering can include clustering types that require minimal computing resources to execute. For example, with tag-based clustering, the cluster creator need only group entities in clusters based on previously assigned shared tags. Due to the minimal computing resources needed, query-time clustering types can be executed in response to the user selecting the clustering type in the GUI. For example, query-time clustering types can be executed after stage 130 below.

Periodic clustering can include clustering types that require complex computing that is time-intensive and may result in long load times for the user if run at the time of the clustering type selection. The time required to execute periodic clustering types can increase exponentially with the size of the network. To solve this problem, periodic clustering types can be executed periodically as a scheduled job, such as every hour, every 2 hours, once a day, or once a week. After completing the job, the cluster creator can save the cluster assignments to a cache where they can be accessed by the server.

In an example, clustering types can be assigned to query-time clustering or periodic clustering by an admin user. An admin can also designate how often periodic clustering jobs are executed. This can allow the admin to optimize the user experience with the GUI and available computing resources. For example, the admin can execute clustering jobs to see how long they take to execute. The execution times can indicate the load time a user would experience if the job were executed on-demand when selected by the user in the GUI. The admin can assign clustering types to query-time or periodic based on an allowable execution time. In one example, the admin can configure clustering types to automatically run as query-time or periodic based on a threshold execution time. For example, as a network grows, generating cluster assignments for some clustering types may take longer and longer to execute. If the average execution time for a clustering type is below the set threshold time, such as 10 seconds, then the cluster assignments for that cluster type can be executed as query-time. Clustering types that average longer than the threshold time can be executed as periodic so that the results can be pulled from the cache, thereby reducing load times for the user. If the execution time of a query-time clustering type extends beyond the threshold time, then the server can automatically switch the clustering type to periodic to reduce load times.

The admin can designate how often a periodic clustering job is executed based on a variety of factors. For example, if the network is generally static (i.e., changes to entities in the network are infrequent), then the admin may schedule the job to run less often to preserve computing resources. However, an admin may schedule a clustering type job to execute more frequently in a dynamic network with frequent entity changes so that the cached data is more up-to-date. In some examples, an admin can set periodic clustering types to be executed dynamically. For example, during times of heavy network usage or increased network changes, the periodic clustering types can automatically run more often, and during times of low network usage or decreased network changes, the periodic clustering types can automatically run less often.

There are various methods that the cluster creators can use for creating cluster assignments. For example, as described previously, for cluster types based on shared data points, the cluster creator can simply assign entities with shared data points to the same clusters. A method for name-based clustering is also described previously. In some clustering types that are more complex, such as with network flows, the cluster creator can use a machine learning (“ML”) model. To do this, the cluster creator can obtain relevant data about the entities, input the relevant data into an ML model, and then use the results from the ML model to create cluster assignments. As an example, relevant data inputted into an ML model for network flow clustering can include data relating to source and destination internet protocol (“IP”) addresses, port numbers, and communication protocols for data exchanges between entities. The data can also include security groups and firewall settings of the entities.

At stage 120, the server can create metadata relating to each cluster. The metadata can include any information about the clusters and the entities assigned to each cluster. This can include information relating to why the entities were assigned to that particular cluster. What information is included in the metadata can depend on the clustering type. For example, metadata for entities clustered according to network flows can include network data specific to the clustered entities, such as their port and communication protocol, any commonly assigned security groups, and any common firewall settings. Metadata for entities clustered by tag can identify the tag applied to entities in the cluster.

The following is an example of creating metadata for a cluster created based on entity names. The metadata for a name-based clustering type can include information about the entity names in each cluster. As an example, a cluster creator can calculate the average name length of entities in each cluster. Using the example described previously of the name format “web-server-prod-[#],” the number of characters in the [#] field can be based on the total number of web servers in the network. For example, if the network has between 100 and 999 web servers, then the [#] can include three characters. Web servers in the 0-99 range can have leading zeroes to maintain the three-digit number, such as “web-server-prod-001” and “web-server-prod-056.” The cluster creator can calculate the name length in various ways. For example, the name length can be the average number of total characters, which in this example would be 19. Alternatively, the cluster creator can calculate the average number of characters between certain characters. For example, for the web server cluster, the average length can be calculated as “3-6-4-3” based on the hyphen locations.

The cluster creator can then determine the most frequent character at each character location in the names of the entities in the cluster. For example, if every entity in the web server cluster begins with “web-server-prod-” then the first character location would be “w,” the second would be “e,” the third would be “b,” and so on. If there are some variations in the entity names, then the most frequent character can be whatever character the largest number of entity names have at the corresponding character location. For example, if 45% of the entity names begin with “w,” 30% begin with “s,” and 25% begin with “t,” then the most frequent character for the first character location would be “w” because the highest percentage of entity names have a “w” in the first character location.

The cluster creator can then create a meta name for each cluster based on the average name length and the most frequent character at each character location. The length of the meta name can be the average name length of entities assigned to the corresponding cluster, and each character in the meta name can be the most frequent character at the corresponding character location. The meta name can be used to create a best guess assignment for entities without a cluster assignment. This is described in more detail at stage 150 below.

At stage 130, the server can receive a user selection of a clustering type. For example, the GUI can include a selection mechanism, such as a drop-down menu, that allows the user to select one of multiple clustering type, such as clustering by names, network flows, and tags. When the user makes the selection, the selection can be sent to the application on the server. For example, where the GUI is part of an application installed on the user device, the application can make an Application Programming Interface (“API”) call to the server with the selection. Alternatively, where the GUI is a web-based application, the browser on the user device can send the selection to the server as a hypertext transfer protocol secure (“HTTPS”) call.

In some examples, the GUI can also allow the user to select a network entity. If a network entity is selected, then the GUI can display a visualization of a portion of the network related to the selected entity. This can be particularly useful with large networks. Rather than displaying clusters for a vast network, and thereby requiring the user to then filter through all the data to find a particular portion of the network, the GUI can display just the clusters in the network related to the selected entity. This saves time for the user and reduces computing resource usage.

At stage 140, the server can identify an entity that does not have a cluster assignment. For example, for periodic clustering types, changes to the network can occur in between scheduled jobs. If the user selects to view the network visualization in the GUI after an entity is added to the network but before a scheduled job runs to assign the new entity to a cluster, then the entity may not yet have a cluster assignment. To address this issue, the application service can access a network database that stores information about the network, including a list of all the entities in the network. This can be the same database and information that the cluster creators access when clustering entities. The application service can compare the entities in the database to the cluster assignments stored in the cache and identify any entities in the network database that are not in the cache.

For query-time clustering types, the application service can identify any entities that do not have the information required to assign the entity to a cluster. For example, for tag-based clustering, the application service can identify any entities that have not been assigned a tag.

At stage 150, the server can create, based on the metadata, a best guess cluster assignment for the second entity. A best guest cluster assignment can be a temporary cluster assignment. For example, for a periodic clustering type, the best guess assignment for an entity can persist until the next scheduled job can create a new cluster assignment based on a full analysis of the network. This allows any newly added entities to be included in the cluster visualization without requiring a full analysis of the network according to the clustering type, which could significantly extend load times for the user.

Continuing the meta name example described previously, the application service, or an assigned cluster creator, can compare the name of the unassigned entity to the meta name of each cluster group. The application service can determine which meta name most closely matches the unassigned entity's name and temporarily assign the unassigned entity to the corresponding cluster group. When the clusters are displayed on the GUI, the entity can be displayed as part of the temporarily assigned cluster group. When the scheduled job for the name-based clustering type next executes, the temporary best guess assignment can be overwritten with whatever assignment the entity receives during the full analysis.

The meta name comparison described above is merely one example of creating a best guess cluster assignment. Creating a best guess cluster assignment can include any simplified analysis that temporarily assigns an unassigned entity to a cluster group without requiring a full analysis of the network according to the clustering type. For example, clustering entities based on network flows can include a complex analysis of how data flows in the network. Instead of redoing the full network analysis, the application service can create a best guess assignment based on one or more shared data points between the unassigned entity and meta data for the cluster groups, such as port numbers, communication protocols, assigned security groups, firewall settings, and so on.

In an example, the application service can save this best guess assignment to the cache as a separate information layer than the cached cluster assignments created from the job execution. The application service can merge the layers for purposes of displaying the cluster groups in the GUI until the next scheduled job executes, at which time the best guest assignment layer can be overwritten by the new data created from the job.

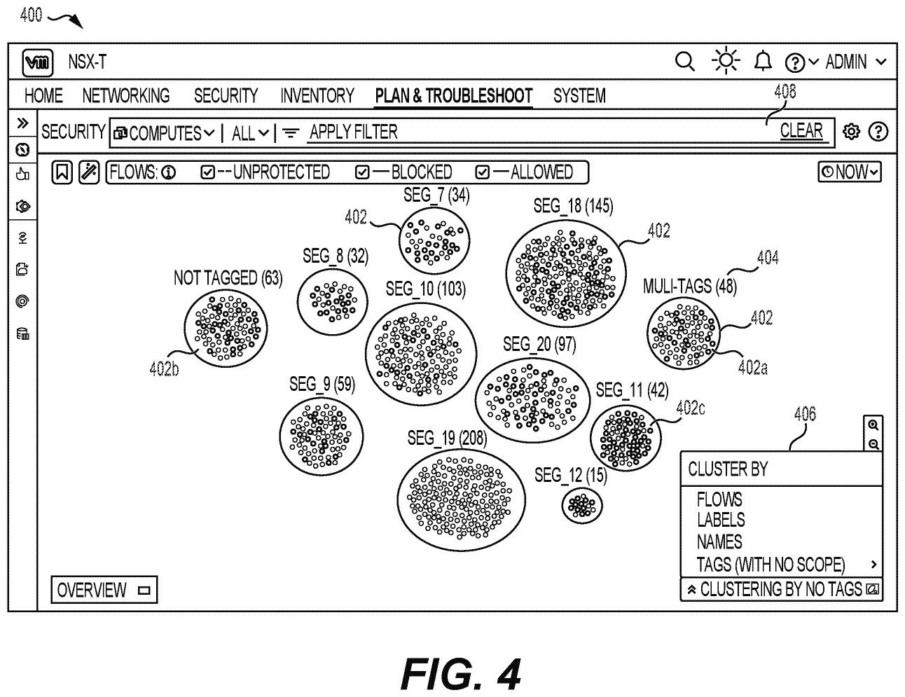

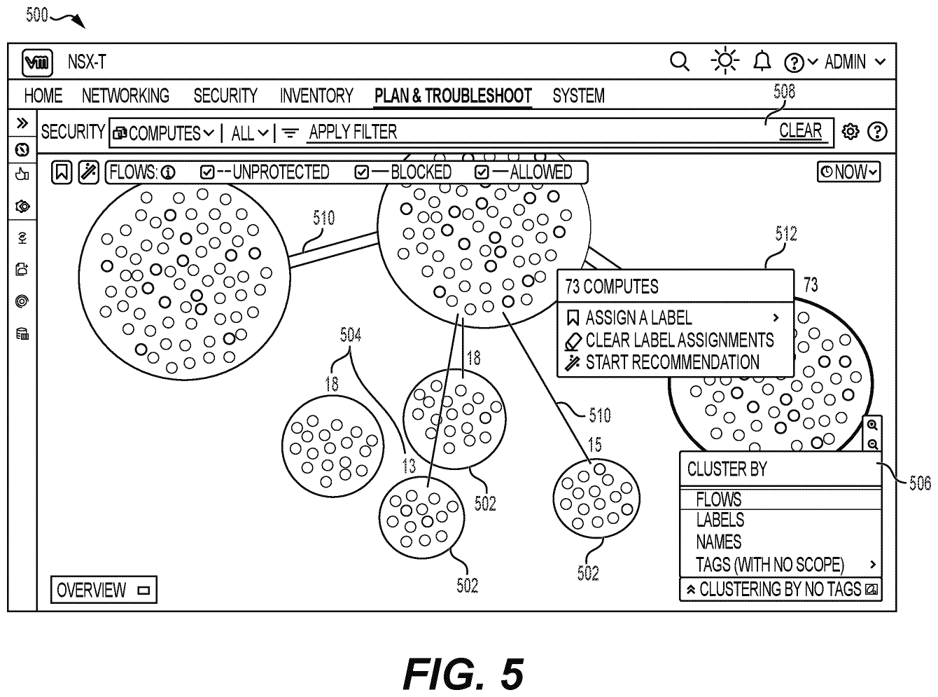

At stage 160, the server can display, in the GUI, a visualization of the clusters. For example, the application service on the server can generate a canvas of the GUI and send the canvas to the user device. A GUI canvas can be a container that holds drawing elements and logically arranges the representation of the drawing elements. As used herein, the term “container” can refer to a class or data structure that stores objects in an organized way following specific access rules. In an example, the GUI canvas can be included as part of a hypertext markup language (“HTML”) file that the application service sends to the user device. The web browser on the user device can then display the GUI to the user. Examples of such a GUI are illustrated in FIGS. 4 and 5 and are described later herein with respect to those figures.

The GUI can allow the user to change the clustering visualization by selecting a different clustering type. The GUI can rearrange itself to group entities based on the newly selected option. As an example, a user can select a tag-based clustering type, which can cause the GUI to display the network entities clustered according to their assigned tags. Tag-based clustering can be a query-time clustering type, so an application service can execute the cluster assignments at the time of selection. The application service can generate the GUI canvas for tag-based clustering and send the canvas to the GUI at the user device for display. The user can then select a network flows clustering type, which can be a periodic clustering type. The application service can retrieve the cluster assignments from the cache and check for any unassigned entities. The application service can create any needed best guess cluster assignments and then generate the GUI canvas using the cached cluster assignments. The application service can send the new GUI canvas to the GUI, and the GUI can rearrange itself based on the new GUI canvas.

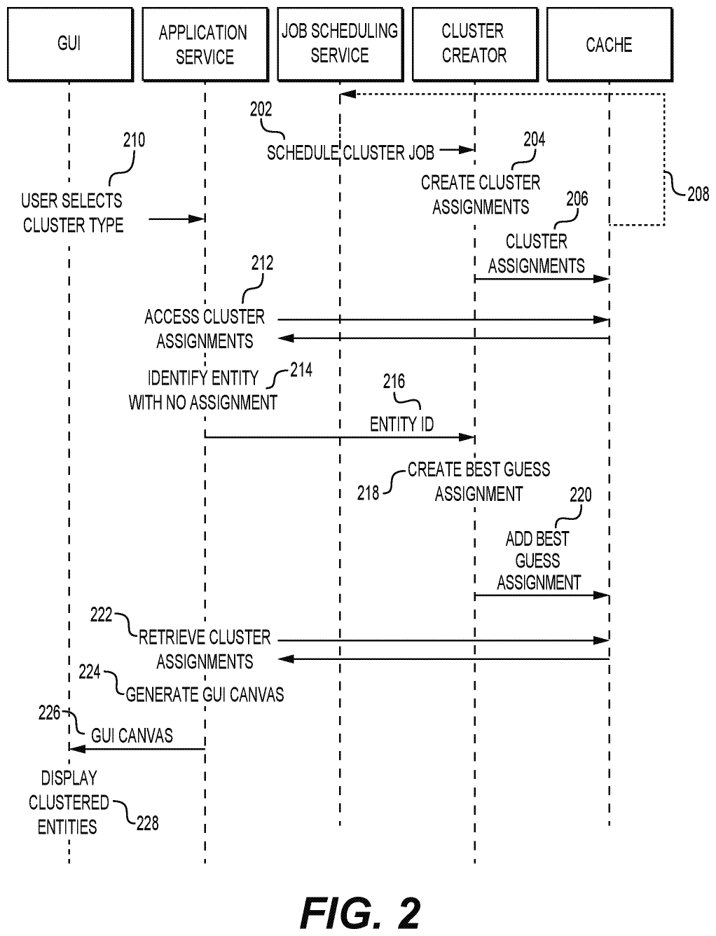

FIG. 2 is a sequence diagram of an example method for providing a GUI for graph-based visualizations of network flows using entity clustering. At stage 202, a job scheduling service can schedule a cluster job. The cluster job can be a job for clustering network entities according to a clustering type. Scheduling the job can include sending instructions to the cluster creator to execute an operation for creating cluster assignments. Although the sequence diagram of FIG. 2 illustrates the job scheduling service scheduling a job at one cluster creator, the job scheduling service can schedule cluster jobs at multiple cluster creators. For example, the job scheduling service can schedule a cluster job for each clustering type available in the GUI. In one example, cluster jobs can be scheduled just for designated periodic clustering types. Query-time clustering types can be executed upon selection by a user in the GUI.

At stage 204, the cluster creator can create cluster assignments for entities in the network. The technique used for creating cluster assignments can depend on the clustering type. Some examples of clustering techniques that can be used are described previously herein regarding stage 110 of FIG. 1. For example, network entities can be clustered based on entity names using one technique and clustered based on network flows using a different technique.

Creating the cluster assignments can include generating metadata for each cluster. The metadata can include any information about the clusters and the entities assigned to each cluster. This can include information relating to why the entities were assigned to that particular cluster.

At stage 206, the cluster creator can save the cluster assignments to a cache. The cache can be any storage medium, such as RAM or a hard disk. The application service can have access to the cache for retrieving the cluster assignments.

At stage 208, the method can return to stage 202 where the job scheduling service can schedule the cluster job again. For example, the cluster job can be scheduled to run periodically. For example, the cluster job can be scheduled every hour or two hours during certain times of the day, such as during business hours. The time between scheduled jobs can depend on various factors, such as the time it takes the cluster creator to complete the job. In examples where the job scheduling service schedules jobs at multiple cluster creators, the jobs can be scheduled at different time intervals. As an example, a name-based clustering type can be scheduled to run every hour, and a network flows-based clustering type can be scheduled to run every two hours. In an example, the job schedules can be set by an admin. If a scheduled job is still executing when the next scheduled time arrives, the cluster creator can be configured to ignore the instructions from the job scheduling service so that it can complete the job already executing.

At stage 210, a user can select a clustering type in a GUI. For example, the GUI can include a selection mechanism, such as a drop-down menu, that allows the user to select one of multiple clustering type, such as clustering by names, network flows, and tags. When the user makes the selection, the GUI, or an associated application or service executing the GUI, can send the selection to the application service on the server.

At stage 212, the application service can access the cluster assignments in the cache. For example, if the cache is part of a database, then the application service can make a database query to the database. Alternatively, the cache can be a storage component of the server. The cluster assignments accessed by the application service can correspond to the selected clustering type. For example, if multiple periodic clustering types are stored in a cache, the application service can identify which cluster assignments to retrieve using an identifier associated with the selected clustering type.

At stage 214, the application service can identify an entity with no cluster assignment. For example, the application service can access a network database that stores information about the network, including a list of all the entities in the network. This can be the same database and information that the cluster creators access when clustering entities. The application service can compare the entities in the database to the cluster assignments stored in the cache and identify any entities in the network database that are not in the cache.

At stage 216, the application service can send the entity ID of any unassigned entities to the cluster creator. The cluster creator can be the same or different from cluster creator that created the cluster assignments for the clustering type. For example, the application service can include a cluster creator for creating best guess cluster assignments. In one example, the application service can include a cluster creator for each method that can be used to create a best guess cluster assignment.

The application service can also send metadata about the unassigned entity. The metadata sent to the cluster creator can depend on the clustering type. For example, if the clustering type is name-based, then the application service can send the name of the entity. If the cluster is network flows-based, then the application service can send network-related metadata that the cluster creator can use to create a best guess assignment.

At stage 218, the cluster creator can create a best guess cluster assignment for the non-assigned entity. The best guess cluster assignment can be created using the metadata related to the unassigned entity. The method used for creating the best guess assignment can depend on the clustering type. Some examples of methods for creating best guess assignments are described in detail regarding stage 150 of FIG. 1 above.

At stage 220, the cluster creator can save the best guess cluster assignment to the cache. The best guess cluster assignment can be saved separate from the already cached cluster assignments. This can allow the best guess cluster assignment to be overwritten when the cluster creator next generates a new set of cluster assignments.

At stage 222, the application service can retrieve the cluster assignments from the cache. In one example, the cluster assignments and the best guess cluster assignment can be stored as separate layers in the cache. The application service can then merge the layers for purposes of creating the GUI canvas.

At stage 224, the application service can generate a GUI canvas. The GUI canvas can be a container that holds drawing elements and logically arranges the representation of the drawing elements. The GUI canvas can include a container for each cluster and containers for other GUI elements, such as tools, drop down menus, a background display, and so on.

At stage 226, the application service can send the GUI canvas to the GUI. For example, if the GUI is web-based and displayed in a web browser, then the application service can send the GUI canvas to the user device's browser in an HTML file.

At stage 228, the GUI can display a visualization of the clusters. For example, the GUI can display the clusters for the selected clustering type and information about the clusters. The GUI can also display information about how the clusters are related to each other. As an example, for network flows clustering, the GUI can display edges that connect clusters based on network communication flows between entities of those clusters. An example of this type of display is described later herein regarding FIG. 5.

The GUI can include an option for selecting a different clustering type. For example, if the GUI is displaying clusters based on a tag-based clustering type, then the user can select another available clustering type, such as name-based or network flows-based. When this happens, the method can return to stage 210 and proceed based on the new selection. The GUI can then rearrange the elements to display clusters based on the most recently selected clustering type.

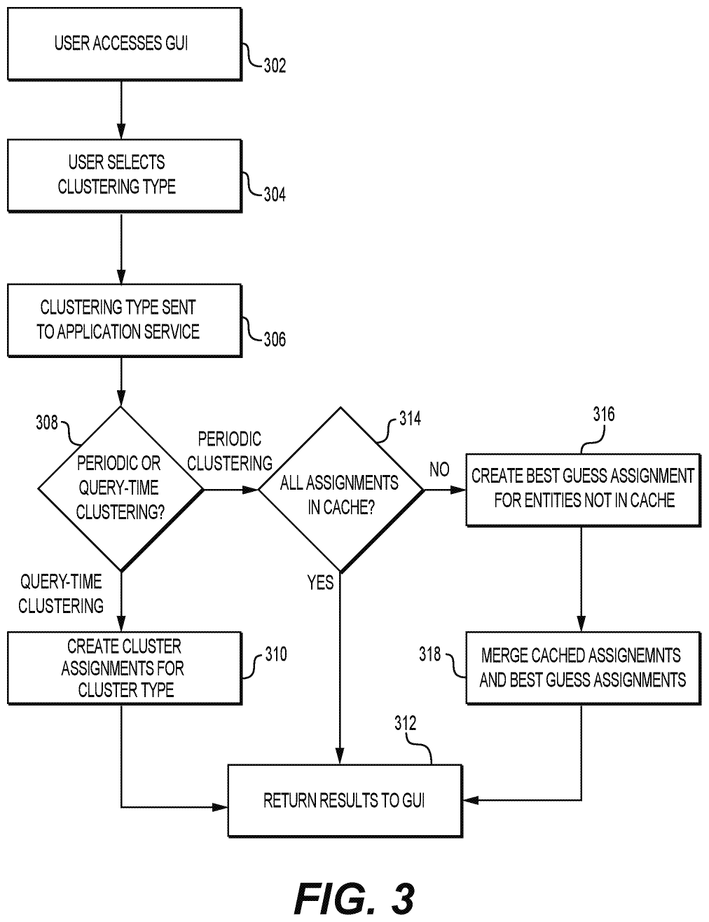

FIG. 3 is another flowchart of an example method for providing a GUI for graph-based visualizations of network flows using entity clustering. This example method illustrates different paths that can be followed when displaying clusters in the GUI. Stages 302, 304, and 306 can take place for any of the possible paths. At stage 302, a user can access the GUI. For example, if the GUI is provided as a web-based application, the user can access the GUI by providing a uniform resources locator (“URL”) for the application into a web browser. The web browser can retrieve a web page for the application using the URL. Alternatively, if the application is installed on a user device, then the user can simply launch the application.

At stage 304, the user can select an entity and a clustering type. For example, the GUI can include a selection mechanism, such as a drop-down menu, that allows the user to select one of multiple clustering type, such as clustering by names, network flows, and tags. The user can select one of the available clustering types and, at stage 306, the entities and clustering type can be sent to the application service. For example, if the GUI is presented in a web browser as a web application, the web browser can send the selection in an HTTPS call to the application service.

At stage 308, the method can proceed in one of two ways, depending on whether the selected clustering type is a query-time clustering type or a periodic clustering type. If the selected clustering type is query-time, then the method can proceed to stage 310 where a cluster creator can create cluster assignments according to the selected clustering type. For example, for tag-based clustering, the application service can assign entities with shared tags to the same clusters. In one example, a cluster creator of the application service can create the cluster assignments. The cluster assignments for query-time clustering can be created in response to the user selection because they can be created with minimal load time to the user.

At stage 312, the clustering can be displayed in the GUI. For example, the application service can create a GUI canvas using the cluster assignments and send the GUI canvas to the user device. The user device can then display the clusters in the GUI according to the GUI canvas.

Returning to stage 308, if the selected clustering type is a periodic clustering type, then the method can proceed to stage 312 where the application service can determine whether all entities in the network have a cluster assignment in the cache. The cache can include data relating to cluster assignments created from scheduled jobs. For example, for periodic clustering types, cluster creators can periodically, or on a schedule, generate cluster assignments based on their respectively designated clustering type. The resulting cluster assignment can be saved to a cache. Each time a cluster creator runs a job, it can overwrite the previous cluster assignments in the cache.

At stage 312, the method can proceed in one of two ways depending on whether any unassigned entities are detected. The application service can compare a list of network entities in a network database to the entities saved to the cache. Any network entities missing from the cache can be considered unassigned entities without a cluster assignment. If all the entities have a cluster assignment, then the method can proceed to 312 where the clusters can be displayed in the GUI using the existing cached cluster assignments.

If any unassigned entities are detected at stage 314, then the method can proceed to stage 316 where the cluster creator can create a best guess assignment such entities. The method used to create the best guess assignments can depend on the clustering type. Examples of such methods are described previously herein.

The method can then proceed to stage 318 where the application service can merge the cached assignments with the best guess assignments. For example, the cluster assignments created from the scheduled jobs can be saved as one layer in the cache, and the best guess cluster assignments can be saved as another layer. After the best guess cluster assignments have been created, the application service can merge the layers so that the unassigned entities have a cluster assignment in the data. The method can then proceed to stage 312 where the clustering can be displayed in the GUI.

FIG. 4 is an illustration of an example GUI 400 for graph-based visualizations of network flows using entity clustering. The GUI 400 displays a visualization of a network using clusters 402 based on pre-assigned tags. The clusters 402 are identified by a cluster name 404. The cluster names 404 in the GUI 400 include the tag name and, in parenthesis, the number of entities assigned to the cluster 402. The size of the clusters 402 vary based on the number of entities assigned to the cluster. For example, the cluster 402 with 145 entities is much larger than the cluster 402 with 15 entities. The GUI 400 includes a multi-tag cluster 402a that includes entities that have been assigned more than one tag. A not-tagged cluster 402b includes entities that have not been assigned a tag. Selecting a cluster 402 can allow the user to view information about the cluster 402, such as a list of the assigned entities. For the multi-tag cluster 402a, the list of entities can indicate the tags assigned to each entity.

The GUI 400 can include a clustering type selection menu 406. The clustering type selection menu 406 can allow a user to change the clustering type displayed. The clustering type selection menu 406 can include a list of available clustering types. For example, the GUI 400 shows that the GUI can display clusters according to network flows, labels, entity names, and tags. The clustering type selection menu 406 also indicates the clustering type currently displayed.

The GUI 400 can include a filter 408 that allows the user to filter the clusters 402 displayed. This can be particularly useful for larger networks with thousands or more entities and a large number of clusters. The user can apply filters to reduce the number of clusters 402 that display so that it is more readable to the user. One example of a filter can allow the user to filter the entities or clusters based on a geographical region that they are associated with. Another example of a filter can allow the user to select specific clusters. For example, the user can select to display only the not tagged cluster 402b so that the user can identify which entities may need to be assigned a tag. The GUI 400 can allow the user to select the not tagged cluster 402b and assign tags to the entities therein. The user can also refresh the clustering, which can cause the application service to recreate cluster assignments with the new assignments made by the user. The filters described above are merely exemplary and not meant to be limiting in any way.

FIG. 5 is another illustration of an example GUI 500 for graph-based visualizations of network flows using entity clustering. The GUI 500 displays a visualization of a network similar to the GUI 400 of FIG. 4, but the GUI 500 is displaying clusters based on network flows. The GUI 500 includes clusters 502 that can correspond to the clusters 402 of FIG. 4, cluster names 504 that can correspond to the cluster names 404, a clustering type selection menu 506 that can correspond to the clustering type selection menu 406, and a filter 508 that can correspond to the filter 408. The cluster names 504 display only the number of entities in the cluster 502 in this example, but they can include any other information for identifying the cluster 502. For example, with name-based clustering, the cluster name 504 can display the meta name of the cluster 502.

The GUI 500 includes edges 510 that indicate network traffic flows between entities in corresponding clusters. The user can select an edge 510 to view more information about the corresponding network traffic, such as IP addresses, ports, communication protocols, security groups, firewall settings, and so on.

The GUI 500 includes a cluster selection menu 512 that can be displayed when a user selects a cluster 502. In this example, the cluster selection menu 512 allows a user to assign a label to the cluster 502, clear previous labels assigned to the cluster 502, and start a recommendation. A recommendation can be a process for recommending firewall rules. Selecting this option can cause the application service to run a process in the background that analyzes network flows related to the selected cluster 502 and provides firewall recommendations. The application service can analyze all the clustered entities at the same time and provide an option in the GUI for applying the recommended firewall settings to all the entities in the cluster 502. This allows the user to do a bulk action for adding firewall settings rather than adding the firewall settings to each entity individually.

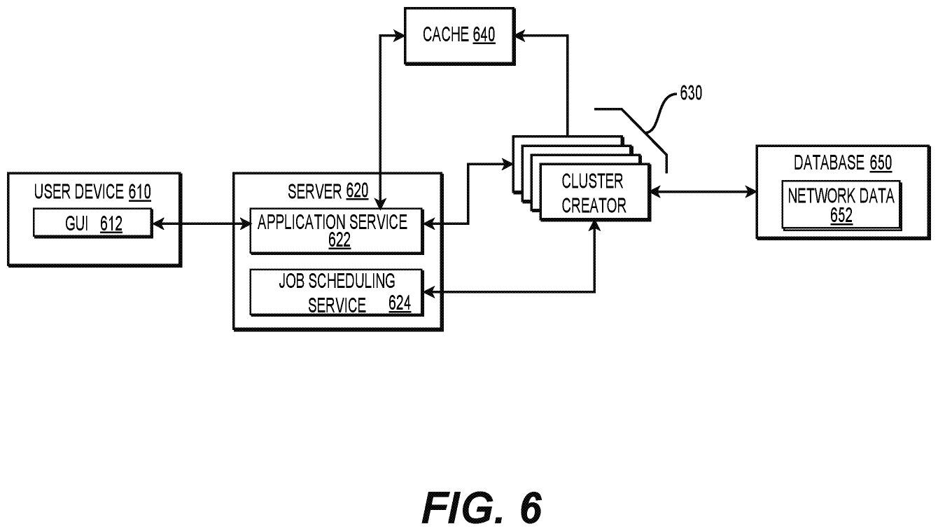

FIG. 6 is an illustration of an example system for providing a GUI for graph-based visualizations of network flows using entity clustering. A GUI 612 can be provided on a user device 610. The GUI 612 can be a front-end interface of an application that provides a visualization of a model of a network, and a user can interface with the GUI 612 to manage the network. One example of such an application is VMWARE's NSX INTELLIGENCE. The user device 610 can be one or more processor-based devices, such as a personal computer, tablet, or cell phone.

The application can be hosted by a server 620. The server 620 can be a single server or a group of servers, including multiple servers implemented virtually across multiple computing platforms. For example, a server 620 can be an OS running on a single computing device or one or more VMs running in a cloud-based environment. In an example, the server 620 can be a web server, and a user can access the application through a web browser at the user device 610.

An application service 622 on the server 620 can execute backend operations of the application. For example, the application service 622 can schedule cluster assignment jobs through a job scheduling service 624, receive user input from the GUI 612, generate displays for the GUI 612 of clustered entities based on a clustering type selected by the user, execute management operations on the network according to user input at the GUI 612, and so on. Many operations that the application service 622 can perform are described previously herein.

The application service 622 can include, or communicate with, one or more cluster creators 630. Cluster creators 630 can be processes that create cluster assignments for network entities according to a specified clustering type. In an example, the application service 622 can include a cluster creator 630 for each clustering type available in the application. The cluster creators 630 can generate cluster assignments using various methods, such as with a statistical analysis or applying network data 652 to an ML model. Network data 652 can include data about a network and the entities therein. The network data 652 can be stored in a database 650 or any other storage medium accessible by the cluster creators 630. The cluster creators 630 can store the cluster assignments in a cache 640, which can be any storage medium that the application service 622 has access to, such as RAM or a hard disk.

Some cluster creators 630 can create cluster assignments periodically and some can create cluster assignments in response to a selection from the user at the GUI 612. For periodic clustering types, the corresponding cluster creator 630 can generate cluster assignments based on instructions from the job scheduling service 624. When the user chooses to view a visualization of the network based on a periodic clustering type, the application service 622 can retrieve the cluster assignments from the cache 640 rather than waiting for the cluster creator 630 to generate a new set of cluster assignments. Each time a cluster creator 630 creates cluster assignments, it can overwrite the previously created assignments retained in the cache 640.

Some cluster creators 630 can be configured to generate best guess cluster assignments. These cluster creators 630 can be used when an entity is missing a cluster assignment. This can occur, for example, when a change has occurred to the network after the most recent cluster creation job was executed and before the user selects to view the network model in the GUI 612. The application service 622 can instruct the cluster creator 630 to generate a best guess cluster assignment and save it to the cache 640. The application service 622 can then merge the assignments and create a GUI canvas with the clustered entities for the GUI 612.

The application service 622 and the user device 610 can communicate using any appropriate communication protocol. For example, if the GUI 612 is provided in an application installed on the user device 610, then the application and application service 622 can communicate using API calls. If the GUI 612 is provided as a web application, then the application service 622 can communicate with the web browser using HTTPs calls, and the application service 622 can send the GUI to the web browser has an HTML file.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for providing a graphical user interface (“GUI”) for graph-based visualizations of network flows using entity clustering, comprising:
assigning entities in the network to a first set of clusters according to a first clustering type;
creating metadata relating to each cluster in the first set of clusters;
receiving a first selection of a first entity and a second selection of the first clustering type;
determining that a second entity does not have a cluster assignment;
creating, based on the metadata, a best guess cluster assignment for the second entity; and
displaying, in a GUI, a visualization of the first set of clusters according to the first clustering type, including displaying the second entity as part of a cluster in the first set of clusters corresponding to the best guess assignment.

2. The method of claim 1, wherein creating the metadata comprises:
calculating, for each cluster in the first set of clusters, an average name length of entities in the cluster;
determining, for each cluster in the first set of clusters, a most frequent character at each character location in the names of the entities in the cluster; and
generating a meta name for each cluster in the first set of clusters, wherein the meta name has a name length equal to the average name length of entities assigned to the corresponding cluster and each character in the meta name being the most frequent character at the character location in the names of the entities in the cluster.

3. The method of claim 2, wherein creating the best guest cluster assignment comprises:
comparing a name of the second entity to meta names of clusters in the first cluster set;
determining which meta name most closely matches the name of the second entity; and
assigning the second entity to the cluster in the first cluster set corresponding to the most closely matched meta name.

4. The method of claim 1, further comprising:
prior to receiving the first user selection, saving the entity assignments to a cache; and
prior to displaying the visualization of entities:
saving the best guest cluster assignment of the second entity to the cache;
retrieving the entity assignments and the best guest cluster assignment from the cache; and
generating a GUI canvas based on the entity assignments and the best guest cluster assignment.

5. The method of claim 1, further comprising:
receiving a third selection of a second clustering type, the second clustering type being based on tags assigned to entities in the network;
retrieving, from a database, information on entity-to-tag mappings;
assigning, based on the mappings, each entity with a mapped tag to a second set of clusters; and
modifying, in the GUI, the visualization of the entities according to assignments of each entity with a mapped tag to the second set of clusters.

6. The method of claim 1, wherein the entities are assigned to the first set of clusters based on at least one of:
similar names of the entities;
processes running on the entities;
network flows between entities; and
security events associated with the entities.

7. The method of claim 1, wherein the entities include an entity selected from at least one of a workload and virtual machine.

8. A non-transitory, computer-readable medium containing instructions that, when executed by a hardware-based processor, causes the processor to perform stages for providing a graphical user interface (“GUI”) for graph-based visualizations of network flows using entity clustering, the stages comprising:
assigning entities in the network to a first set of clusters according to a first clustering type;
creating metadata relating to each cluster in the first set of clusters;
receiving a first selection of a first entity and a second selection of the first clustering type;
determining that a second entity does not have a cluster assignment;
creating, based on the metadata, a best guess cluster assignment for the second entity; and
displaying, in a GUI, a visualization of the first set of clusters according to the first clustering type, including displaying the second entity as part of a cluster in the first set of clusters corresponding to the best guess assignment.

9. The non-transitory, computer-readable medium of claim 8, wherein creating the metadata comprises:
calculating, for each cluster in the first set of clusters, an average name length of entities in the cluster;
determining, for each cluster in the first set of clusters, a most frequent character at each character location in the names of the entities in the cluster; and
generating a meta name for each cluster in the first set of clusters, wherein the meta name has a name length equal to the average name length of the corresponding cluster and each character in the meta name being the most frequent character at the character location in the names of the entities in the cluster.

10. The non-transitory, computer-readable medium of claim 10, wherein creating the best guest cluster assignment comprises:
comparing a name of the second entity to meta names of clusters in the first cluster set;
determining which meta name most closely matches the name of the second entity; and
assigning the second entity to the cluster in the first cluster set corresponding to the most closely matched meta name.

11. The non-transitory, computer-readable medium of claim 8, the stages further comprising:
prior to receiving the first user selection, saving the entity assignments to a cache; and
prior to displaying the visualization of entities:
saving the best guest cluster assignment of the second entity to the cache,
retrieving the entity assignments and the best guest cluster assignment from the cache, and
generating a GUI canvas based on the entity assignments and the best guest cluster assignment.

12. The non-transitory, computer-readable medium of claim 8, the stages further comprising:
receiving a third selection of a second clustering type, the second clustering type being based on tags assigned to entities in the network;
retrieving, from a database, information on entity-to-tag mappings;
assigning, based on the mappings, each entity with a mapped tag to a second set of clusters; and
modifying, in the GUI, the visualization of the entities according to assignments of each entity with a mapped tag to the second set of clusters.

13. The non-transitory, computer-readable medium of claim 8, wherein the entities are assigned to the first set of clusters based on one selected from:
similar names of the entities,
processes running on the entities,
network flows between entities, and
security events associated with the entities.

14. The non-transitory, computer-readable medium of claim 8, wherein the entities include an entity selected from at least one of a workload and virtual machine.

15. A system for providing a graphical user interface (“GUI”) for graph-based visualizations of network flows using entity clustering, comprising:
a memory storage including a non-transitory, computer-readable medium comprising instructions; and
a hardware-based processor that executes the instructions to carry out stages comprising:
assigning entities in the network to a first set of clusters according to a first clustering type;
creating metadata relating to each cluster in the first set of clusters;
receiving a first user selection of a first entity and a second selection of the first clustering type;
determining that a second entity does not have a cluster assignment;
creating, based on the metadata, a best guess cluster assignment for the second entity; and
displaying, in a GUI, a visualization of the first set of clusters according to the first clustering type, including displaying the second entity as part of a cluster in the first set of clusters corresponding to the best guess assignment.

16. The system of claim 15, wherein creating the metadata comprises:
calculating, for each cluster in the first set of clusters, an average name length of entities in the cluster;
determining, for each cluster in the first set of clusters, a most frequent character at each character location in the names of the entities in the cluster; and
generating a meta name for each cluster in the first set of clusters, wherein the meta name has a name length equal to the average name length of the corresponding cluster and each character in the meta name being the most frequent character at the character location in the names of the entities in the cluster.

17. The system of claim 16, wherein creating the best guest cluster assignment comprises:
comparing a name of the second entity to meta names of clusters in the first cluster set;
determining which meta name most closely matches the name of the second entity; and
assigning the second entity to the cluster in the first cluster set corresponding to the most closely matched meta name.

18. The system of claim 15, the stages further comprising:
prior to receiving the first user selection, saving the entity assignments to a cache; and
prior to displaying the visualization of entities:
saving the best guest cluster assignment of the second entity to the cache,
retrieving the entity assignments and the best guest cluster assignment from the cache, and
generating a GUI canvas based on the entity assignments and the best guest cluster assignment.

19. The system of claim 15, the stages further comprising:
receiving a third selection of a second clustering type, the second clustering type being based on tags assigned to entities in the network;
retrieving, from a database, information on entity-to-tag mappings;
assigning, based on the mappings, each entity with a mapped tag to a second set of clusters; and
modifying, in the GUI, the visualization of the entities according to assignments of each entity with a mapped tag to the second set of clusters.

20. The system of claim 15, wherein the entities are assigned to the first set of clusters based on one of:
similar names of the entities;
processes running on the entities;
network flows between entities; and
security events associated with the entities.
